(19) United States
(12) Patent Application Publication
(10) Pub. No.: US 2024/0352998 A1
(43) Pub. Date: Oct. 24, 2024

(54) Supplemental Cover for Vented Cap

(71) Applicant: USA as represented by Secretary of the Army, Washington, DC (US)

(72) Inventors: Wyatt Walsh, Laceys Spring, AL (US); Thomas Dupuy, Madison, AL (US)

(73) Assignee: USA as represented by Secretary of the Army, Washington, DC (US)

(21) Appl. No.: 18/304,089

(22) Filed: Apr. 20, 2023

(51) Int. Cl. F16H 57/04; F16H 57/027; F16H 57/029; F16H 57/031

(52) U.S. Cl. CPC F16H 57/0408; F16H 57/027; F16H 57/029; F16H 57/031

(57) ABSTRACT

The present disclosure provides a supplemental cover to protect a vented cap against water infiltration. The supplemental cover includes a mounting portion and an upper portion. The mounting portion has a sealing lip that fits around the rim of the vented cap and beveled tabs protruding from the sealing lip which act to hold the supplemental cover in place. The upper portion has a top plate encompassed by a downward sloping runoff, which directs water away from the vented cap. The upper portion also includes a plurality of handles that protrude outwards from the runoff. The upper portion is configured to cover the vented cap when the mounting portion releasably attaches the supplemental cover to the vented cap such that the supplemental cover inhibits water from penetrating the vented cap.

### FIELD

The present disclosure generally relates to a supplemental cover, and more specifically, a supplemental cover that mounts onto a vented cap of a machine, e.g., the transmission fluid cap on a light utility helicopter (LUH) or other vehicle, to protect the cap from the infiltration of water.

### BACKGROUND

During washing procedures, water can penetrate a vented cap. This can cause mixing of water with the operating fluid enclosed by the cap, potentially reducing the effectiveness of the operating fluid. In the case of a LUH transmission fluid cap, infiltration of water can reduce the lubricity of the transmission fluid and potentially cause transmission failure in the LUH.

### BRIEF SUMMARY

In one embodiment, the present disclosure provides a supplemental cover to protect a vented cap against water infiltration. The supplemental cover includes a mounting portion and an upper portion. The mounting portion has a sealing lip that fits around the rim of the vented cap and beveled tabs protruding from the sealing lip which act to hold the supplemental cover in place. The upper portion has a top plate circumscribed by a downward sloping runoff which dispels most of the water from the vented cap and provides a base for the supplemental cover. The upper portion also includes a plurality of handles that protrude outward from the runoff. The bottom of each handle has an indentation in order to allow for the handles to better fit in the hand. The handles provide for easy mounting and unmounting of the supplemental cover from the vented cap. A recess on the underside of the top plate provides for the vent upon the vented cap to rest in.

Other aspects and features will be apparent hereinafter.

### BRIEF DESCRIPTION OF DRAWINGS

For a better understanding of the nature and objects of the disclosure, reference should be made to the following detailed description taken in conjunction with the accompanying drawings, in which:

FIG. 1 is an illustration of an isometric view of the supplemental cover.

FIG. 2 is a side-view illustration of the supplemental cover.

FIG. 3 is a bottom-view illustration of the supplemental cover.

FIG. 4 is a top-view illustration of the supplemental cover.

FIG. 5 is a cross-section view illustration of the supplemental cover taken along line A-A in FIG. 4.

FIG. 6 is an illustration of an isometric view of the transmission fill cap.

Reference is made in the following detailed description of one or more embodiments to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim.

### DETAILED DESCRIPTION

The inventors have recognized an issue with the washing procedures of machines with vented caps. During the washing procedures, water can penetrate the vented cap and mix with the fluid in the capped tank. This can dilute the operating fluid enclosed by the can, which can adversely affect operating fluid effectiveness. In the case of a LUH transmission fluid cap, infiltration of water can reduce the lubricity of the transmission fluid and potentially cause transmission failure. Hence, there is a need for a method or device that can prevent the penetration of water. As explained in further detail below, in the present disclosure, the inventors provide a supplemental cover to direct water flow away from the vented cap to prevent water infiltration during washing procedures.

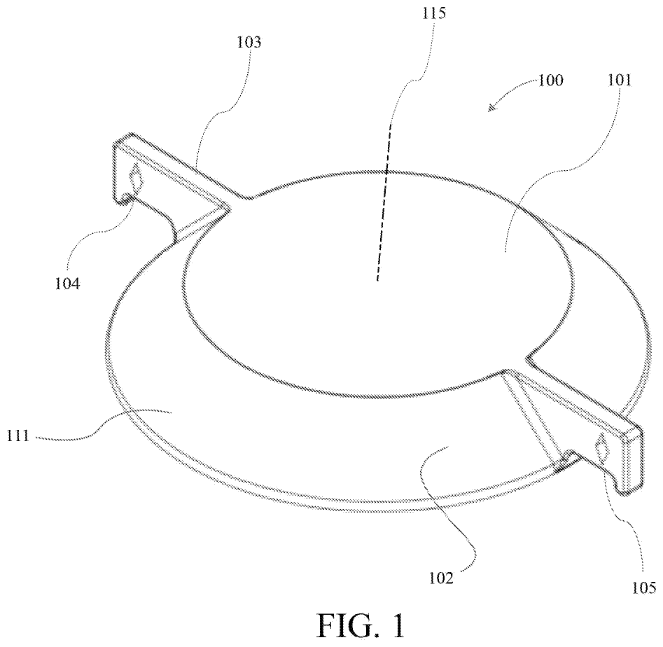

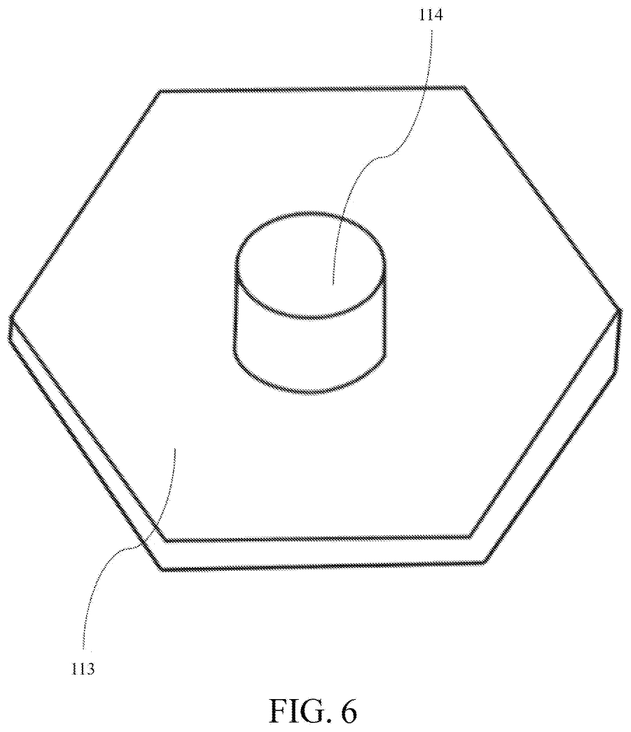

As shown in FIGS. 1-5, the present disclosure provides a supplemental cover 100. As best seen in FIG. 1, the supplemental cover 100 includes an upper portion 111. The upper portion 111 further includes a pair of handles 103, a top plate 101, and a runoff 102. In certain embodiments, the top plate 101 is circular. The runoff 102 extends circumferentially around the top plate 101 and slopes downward as it extends radially outward toward its outer perimeter. Further, in one or more embodiments, the face of the runoff 102 is generally planar. The top plate 101 and the runoff 102 are configured to deflect and redirect water away from a vented cap 113 (shown in FIG. 6) of a LUH.

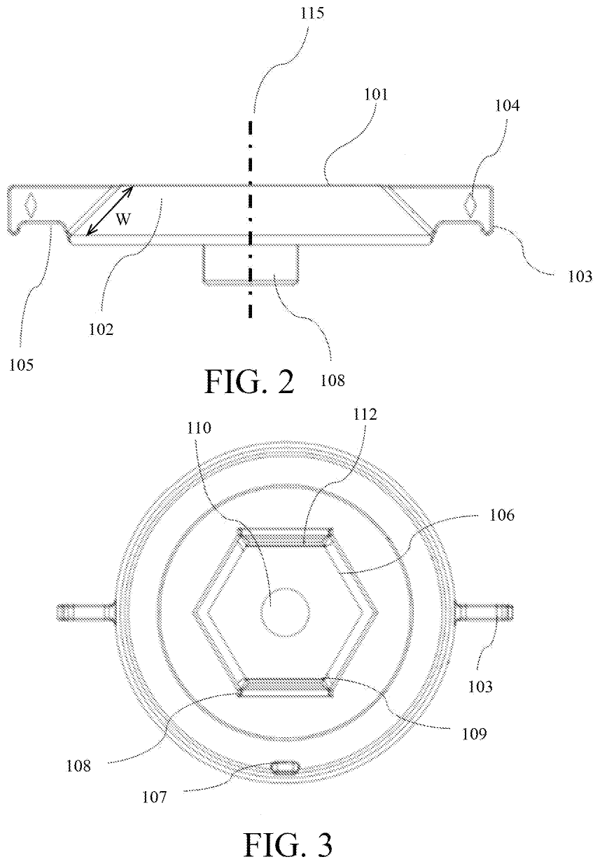

As shown in FIG. 2, in many embodiments the handles 103 are generally rectangular in shape and have a top face that is coplanar with the top plate 101. The handles 103 attach to a main body of the supplemental cover 100 by spanning the width W of the runoff 102. In some embodiments, there are indentations 105 on a bottom face of the handles 103. The indentions 105 are configured to aid an individual's finger to grip of the handles 103 when removing or installing the supplemental cover 100. Additionally, some embodiments include a hole 104 through the sides of each handle 103. The holes 104 allow the supplemental cover 100 to be hung for storage purposes. The holes 104 can be used with a hanger or rope to store the supplement cover 100 in a hanging configuration. The handles 103 interact in such a way with the supplemental cover 100 that unmounting only requires the lifting of one of the handles.

As shown in FIG. 3 (bottom view of supplemental cover 100) and in FIG. 5 (cross-section view of supplemental cover 100), the supplemental cover 100 further includes a mounting portion 112. In one or more embodiments, the mounting portion 112 includes a sealing lip 106 and a plurality of tabs 108 which are configured to operatively mount the supplemental cover 100 to the vented cap 113 or a LUH. The tabs 108 may protrude downward from any opposing pair of sealing lips 106.

Further, in one or more embodiments, the supplemental cover 100 can be made from a monolithic piece of material and can be easily produced through an additive manufacturing process. The inventors believe that a geometry of the illustrated cover 100 is optimized for additive manufacturing so that the top of the cover 100 forms a base of an additively manufactured three-dimensional print. In this way, the cover 100 can be formed without support material and on a wide array of printing equipment. Additionally, in one or more embodiments, all parts of the invention have circular symmetry around the center axis 115 of the supplemental cover 100.

Continuing with bottom view FIG. 3, the sealing lip 106 is jointed with the tabs 108 and serves to support the supplemental cover 100 on the vented cap 113 (FIG. 6). In one or more embodiments, the tabs 108 include a plurality of interior facing triangular-prism shaped bevels 109 to grip onto the vented cap 113. The supplemental cover 100 is configured to be pushed downward onto the vented cap 113, whereby the supplemental cover makes a press fit connection to the vented cap and supports itself on the vent 114 of the vented cap. The press fit connection fastens the supplemental cover 100 and the vented cap 113 together. As further seen in FIG. 3, in one or more embodiments the shape of the sealing lip 106 is that of a hexagon. The supplemental cover 100 is easily removeable, and some embodiments include a small lanyard hole 107 around a bottom edge of the runoff 102 (FIG. 2) configured to enable the attachment of an informational lanyard.

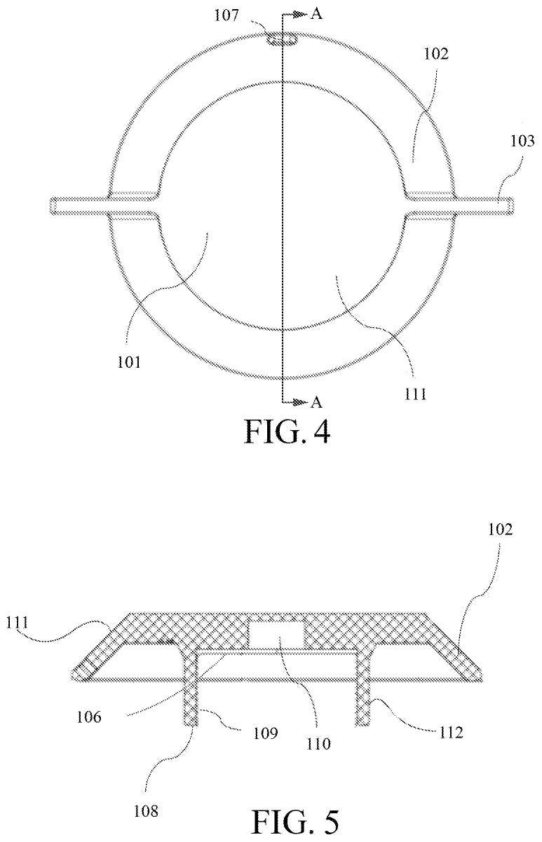

FIG. 4 is a top-view illustration of the supplemental cover. Features introduced earlier and also visible in this view include the upper portion 111 having the top plate 101, the runoff 102, and the handles 103. Also visible in FIG. 4 is the small lanyard hole 107.

Turning again to FIG. 5, the upper portion 111 comprises a recess 110. The recess 110 is a cylindrically shaped negative space centered on the bottom face of the upper portion 111. The recess 110 allows further stability by receiving a vent 114 (FIG. 6) of the vented cap 113 (FIG. 6). Further, the recess 110 can fully surround the vent 114 preventing any residual water from entering the vented cap 113.

FIG. 6 is an illustration of an isometric view of transmission fill cap 113. The vented cap 113 makes a press fit connection with the supplemental cover 100 (FIG. 1), where the vent 114 of the vented cap 113 supports the supplemental cover 100.

The foregoing description has been presented for the purposes of illustration and description. It is not intended to be exhaustive or to limit the disclosure to the precise form disclosed. Many modifications and variations are possible in view of this disclosure. Indeed, while certain features of this disclosure have been shown, described and/or claimed, it is not intended to be limited to the details above, since it will be understood that various omissions, modifications, substitutions and changes in the apparatuses, forms, method, steps and system illustrated and, in its operation, can be made by those skilled in the art without departing in any way from the spirit of the present disclosure.

Furthermore, the foregoing description, for purposes of explanation, used specific nomenclature to provide a thorough understanding of the disclosure. However, it will be apparent to one skilled in the art that the specific details are not required in order to practice the disclosure. Thus, the foregoing descriptions of specific embodiments of the present disclosure are presented for purposes of illustration and description. They are not intended to be exhaustive or to limit the disclosure to the precise forms disclosed, many modifications and variations are possible in view of the above teachings. The embodiments were chosen and described in order to best explain the principles of the disclosure and its practical applications, to thereby enable others skilled in the art to best utilize the disclosed system and method, and various embodiments with various modifications as are suited to the particular use contemplated.

1. A supplemental cover for a vented cap, the supplemental cover comprising:
a body having a mounting portion and an upper portion;
the mounting portion being configured to releasably attach to the vented cap by operatively mounting the supplemental cover on said vented cap; and
the upper portion being configured to cover the vented cap when the mounting portion releasably attaches the supplemental cover on said vented cap such that said supplemental cover inhibits water from penetrating said vented cap;
wherein the supplemental cover has a center axis, the body of the supplemental cover being symmetrical about the center axis;
wherein the mounting portion comprises a sealing lip, the sealing lip configured to encompass the vented cap and inhibit water penetration when the mounting portion mounts the supplemental cover on said vented cap;
wherein the sealing lip comprises a plurality of tabs, wherein the tabs extend from the sealing lip and are configured to mount the supplemental cover on the vented cap; and
wherein the plurality of tabs comprises a pair of triangular-prism shaped bevels, wherein the pair of the bevels lie diametrically opposed on center-facing sides of the tabs, wherein the pair of bevels are configured to grip the vented cap to inhibit the supplemental cover from moving relative to the vented cap.

2. (canceled)

3. (canceled)

4. (canceled)

5. The supplemental cover of claim 1, wherein the sealing lip has a shape corresponding to a shape of the vented cap.

6. The supplemental cover of claim 5, wherein the shape of the sealing lip is a polygon.

7. (canceled)

8. (canceled)

9. The supplemental cover of claim 1, wherein the upper portion comprises: a top plate and a runoff, wherein the top plate is flat and centered around a center axis, and wherein the runoff is a downward sloping piece outboard of the top plate for directing water can flow off the supplemental cover.

10. The supplemental cover of claim 9, wherein the runoff defines a lanyard hole for attaching of an informational lanyard to the supplemental cover.

11. The supplemental cover of claim 9, wherein the upper portion further comprises a pair of handles having a connecting portion and an end portion, wherein the handles are diametrically opposed on the supplemental cover, wherein each handle has a top coplanar with the top plate, and wherein the connecting portion spans the runoff.

12. The supplemental cover of claim 11, wherein the pair of handles has a lower indentation.

13. The supplemental cover of claim 12, wherein each handle includes a hole for suspending the supplemental cover in storage.

14. The supplemental cover of claim 9, wherein the upper portion further comprises a recess, the recess on an underside of the top plate for receiving a vent of the vented cap.

15. (canceled)

16. The supplemental cover of claim 14, wherein the recess is configured to stabilize the supplemental cover on the vented cap.

17. A supplemental cover for a vented cap, the supplemental cover comprising:
a body having a mounting portion and an upper portion;
the mounting portion being configured to releasably attach to the vented cap by operatively mounting the supplemental cover on said vented cap;
the upper portion being configured to cover the vented cap when the mounting portion releasably attaches the supplemental cover to the vented cap such that said supplemental cover inhibits water from penetrating the vented cap; and
wherein the supplemental cover is manufacturable by additive manufacturing;
wherein the supplemental cover has a center axis, the body of the supplemental cover being symmetrical about the center axis;
wherein the mounting portion comprises a sealing lip, the sealing lip configured to encompass the vented cap and inhibit water penetration when the mounting portion mounts the supplemental cover on said vented cap;
wherein the sealing lip comprises a plurality of tabs, wherein the tabs extend from the sealing lip and are configured to mount the supplemental cover on the vented cap; and
wherein the plurality of tabs comprises a pair of triangular-prism shaped bevels, wherein the pair of the bevels lie diametrically opposed on center-facing sides of the tabs, wherein the pair of bevels are configured to grip the vented cap to inhibit the supplemental cover from moving relative to the vented cap.

18. The supplemental cover of claim 17, wherein the supplemental cover is constructed of a monolithic material.

19. The supplemental cover of claim 17, wherein the supplemental cover is mounted onto a light utility helicopter transmission fill cap.
